(19) United States
(12) Patent Application Publication
(10) Pub. No.: US 2014/0202592 A1
(43) Pub. Date: Jul. 24, 2014

(54) FILLING DEVICE

(71) Applicant: KHS GmbH, Dortmund (DE)

(72) Inventors: Ludwig Clusserath, Bad Kreuznach (DE); Timo Jakob, Framersheim (DE); Thomas Stolte, Bad Kreuznach (DE)

(73) Assignee: KHS GmbH, Dortmund (DE)

(21) Appl. No.: 14/241,209

(22) PCT Filed: Jun. 28, 2012
(86) PCT No.: PCT/EP2012/002708

§ 371 Date: Feb. 26, 2014

(30) Foreign Application Priority Data
Aug. 26, 2011 (DE) 10 2011 111 321.9

(51) Int. Cl. B67C 3/24

(52) U.S. Cl. CPC B67C 3/24
USPC 141/165

(57) ABSTRACT

An apparatus for filling cans with an uncarbonated liquid fill includes a rotatable rotor, can holders, filling elements, a can-pickup station, a can set-down station, and either a movable clamping element or an underpressure acting on a can's bottom. The filling operation is either pressureless filling, free-jet filling, or hot free-jet filling. During a filling operation, the rotor moves a can from the pick-up station to the set-down station. Either the clamping element or the underpressure then fixes the can to either a circumferential side with respect to the rotor or a filling-element support.

### RELATED APPLICATIONS

Under 35 USC 371, this application is the national stage entry of PCT/EP2012/002708, filed Jun. 28, 2012, which claims the benefit of the Aug. 26, 2011 priority date of German application DE 10 2011 111 321.9, the contents of which are herein incorporated by reference.

### FIELD OF INVENTION

The invention relates to a device for filling cans or similar containers with a liquid fill, for example with an uncarbonated liquid fill.

### BACKGROUND

Generic devices for filling cans or similar containers with a liquid fill, for example with an uncarbonated liquid fill, are known. These devices comprise, for example, a rotor that can be driven to rotate about a vertical machine axis, the rotor having a large number of filling positions, each with a can holder and with a filling element arranged above the can holder on the rotor or on a filling element support located there. The cans to be filled are fed to the rotor or to the filling positions at a can pick-up station and are moved by the rotor to a can set-down station.

In order to accurately fix the can's position or orientation relative to the filling element, it is known to provide a fixing and centering bell on the filling element and to move he filling element and the can to be filled relative to one another in such a way that the can is centered by the fixing and centering bell and is held with its can opening bearing tightly against the filling element.

One disadvantage of this is that the centering bells result in considerable design complexity and that the touching of the top of the cans by the fixing and centering bells risks contaminating the cans and the fill accommodated inside the cans. Unfortunately, the contamination even of just one fixing and centering bell results in the contamination of whole batches of cans.

### SUMMARY

An object of the invention is to provide a device for filling cans with a fill that, with a simplified design and with high operational reliability, reduces the risk of contamination of the cans to be filled and of the fill contained therein and at the same time optimally fixes the can relative to the filling element in the correct position.

An essential aspect of the device according to the invention is that between a can pick-up station and a can set-down station, without touching a filling element, and with either its opening exposed or with its opening's rim exposed, the can is fixed at least temporarily on the circumferential side with respect to the rotor and/or to the filling element support and/or that the can is fixed at least temporarily with respect to the rotor by an underpressure acting on the can bottom.

Within the context of the invention, free-jet filling is to be understood to mean a method in which the liquid fill flows in a free jet of fill towards a can that is to be filled, wherein the can does not bear with its can opening against the filling element but rather is spaced apart from the filling element and from a filling element outlet opening located there.

In one preferred embodiment, the filling device is designed for a hot free-jet filling or hot aseptic free-jet filling of the cans in which hot fill is introduced into the cans in a free jet of fill.

Within the context of the invention, the expression “essentially” or “approximately” means deviations of +/−10%, preferably +/−5%, from the exact value in each case and/or deviations in the form of changes that do not affect the function.

### BRIEF DESCRIPTION OF THE FIGURES

Further developments of the invention form the subject matter of the dependent claims. The invention will be explained in more detail below with reference to the figures and on the basis of examples of embodiments. In the figures:

FIG. 1 shows a filling device according to the invention in a sectional plane that includes the vertical machine axis;

FIG. 2 shows a filling device according to the invention in a perspective partial view;

FIG. 3 shows the filling device according to the invention as shown in FIG. 2, with a can fixed in a positionally accurate manner;

FIG. 4 shows a schematic sectional view of a rotor of a filling device according to the invention, with a can fixed to the rotor or to a filling position by underpressure;

FIG. 5 shows a schematic sectional view of an alternative embodiment in which the rotor of the filling device according to the invention with a can fixed to the rotor using compressed air; and

FIG. 6 shows a schematic sectional view of the rotor of the filling device according to the invention, with a can fixed to the rotor using compressed air in a further variant embodiment.

### DETAILED DESCRIPTION

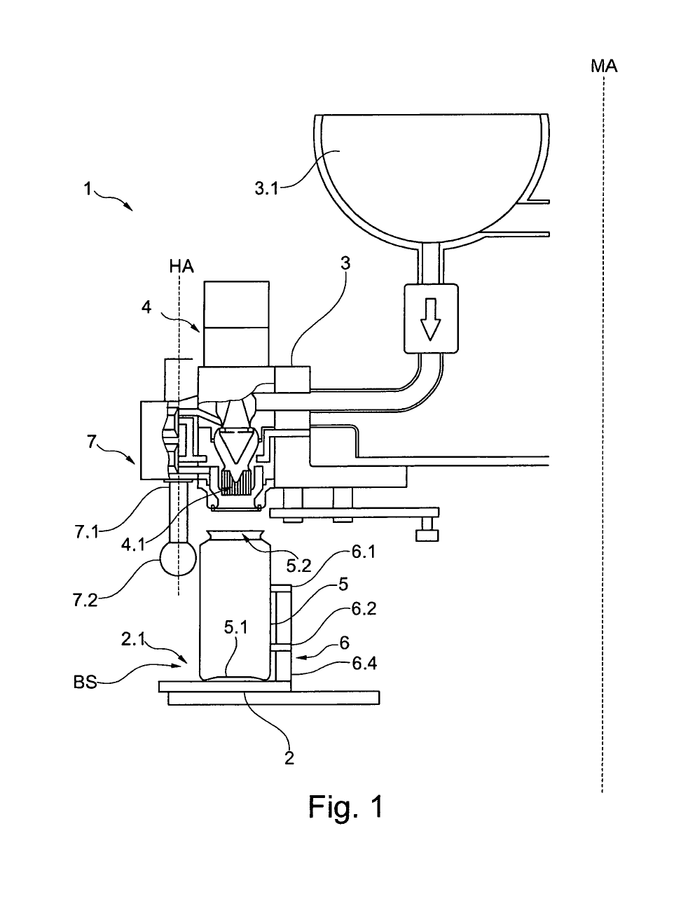

In FIGS. 1 to 3, reference 1 in each case denotes a filling device of the rotary type according to the invention in a first example embodiment.

The filling device 1, which is designed for the pressureless filling or free-jet filling, preferably for the hot free-jet filling, of cans with an uncarbonated liquid, comprises a rotor 2 that can be driven to rotate about a vertical machine axis MA and which has a large number of can holders 2.1.

Provided above the rotor 2 are filling elements 4 that are assigned to the respective can holders 2.1 and that, in each case together with the respectively associated can holders 2.1, form a plurality of filling locations. The filling elements 4 are provided on a ring-shaped filling element support 3 in a manner spaced apart from one another at fixed angular spacings, wherein the filling element support 3 is attached to the rotor 2 and can be driven in rotation jointly therewith about the vertical machine axis MA.

As indicated by the arrow denoted BS in FIG. 1, the cans 5 are pushed in at a can pick-up station, for example in a radial direction relative to the machine axis MA, so that in each case one can 5 is arranged resting with its can bottom 5.1 on a can holder 2.1 and with its can axis parallel to the machine axis MA.

Provided above the can holders 2.1, in a direction parallel to the machine axis MA, is in each case the associated filling element 4, which has a fill outlet or filling element outlet 4.1 that is arranged above the can opening 5.2 and at a distance therefrom. The rotor 2 and the filling element support 3 are driven in synchrony with one another in rotation about the machine axis MA so that as the rotor 2 rotates, the can 5 is arranged with its can opening 5.2 always centered below the filling element outlet 4.1 of the filling element 4 and thus can be filled with the fill or with the liquid in the angular range of the rotational movement of the rotor 2 between the can pick-up station and the can set-down station.

The filling elements 4 are each connected via pipelines to a ring bowl 3.1 for holding the fill, the ring bowl being arranged above the filling element support 3. Provided in each of the filling elements 4 is a liquid valve that is opened and closed in a controlled manner in order to achieve the desired fill level and/or fill quantity in the can 5.

In contrast to known methods, the filling of the cans 5 takes place in a pressureless manner using a free jet, wherein no contact takes place between the filling element 4 and the can 5, in particular the can opening 5.1 and the rim of the opening. This effectively avoids contamination of the can 5 and of the liquid fill introduced into the can. In order nevertheless to achieve the necessary fixing and centering of the can 5 on the rotor 2, each can 5 is fixed at least temporarily on the circumferential side with respect to the rotor 2 and/or to the filling element support 3, specifically mechanically and/or by means of an underpressure acting on the can bottom 5.1.

In the example of embodiment shown in FIGS. 1 to 3, the fixing of the can 5 takes place mechanically by means of a clamping of the can 5 between a holder 6, which is arranged in a stationary manner on the rotor 2, and a movable clamping element 7.

In the illustrated example of embodiment shown in FIGS. 1 to 3, the holder 6 is formed by a holder mount 6.4 that protrudes towards the filling element support 3 from the part of the rotor 2 forming the can holders 2.1, and a first and a second holder element 6.1, 6.2 arranged on the holder mount 6.4. Here, the holder elements 6.1, 6.2 are preferably arranged to be spaced apart from one another in the direction of the machine axis MA so that spatially distributed bearing surfaces are formed by the holder 6 along the vertical axis of the can 5.

With particular preference, the first and second holder elements 6.1, 6.2 have arc-shaped recesses 6.3, the arc radius of which is adapted to the radius of the can 5 to be held to form an at least partially circumferential bearing surface for the can 2. In the illustrated embodiment, the arc-shaped recesses 6.3 are open radially towards the outside in relation to the machine axis MA so that the cans 5 at the can pick-up station, with respect to the machine axis MA, can be placed radially inwards onto the rotor 2 and can be pushed radially inwards onto the can holding locations 2.1, so that, in the end position, the can bears with part of its circumference against the first and second holder element 6.1, 6.2.

Cutouts 2.2 that are adapted to the respective can bottom 5.1 can preferably be provided in the rotor 2. These cutouts bring about additional lateral guidance and centering of the can 5 when the can is pushed in at the can pick-up station.

As shown in the illustrated embodiment, holder elements 6.1, 6.2, which are in the shape of a ring or a segment of a ring, may be provided as the holders 6, with the holder elements have a large number of arc-shaped recesses 6.3 arranged on the outer circumference. As an alternative, individual holders 6 may also be provided, wherein in each case one such individual holder is assigned to a can holder 2.1 or a filling element 4.

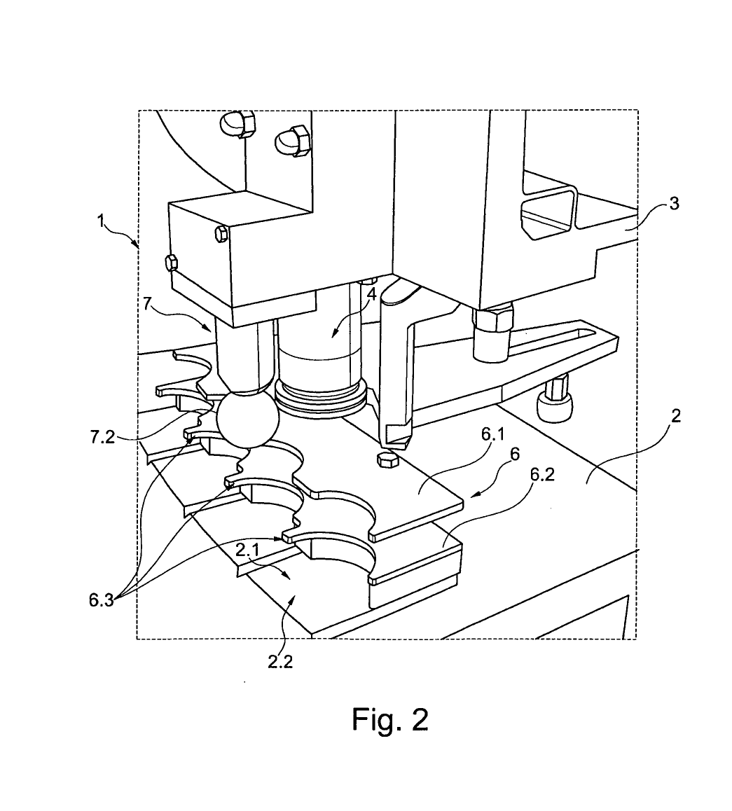

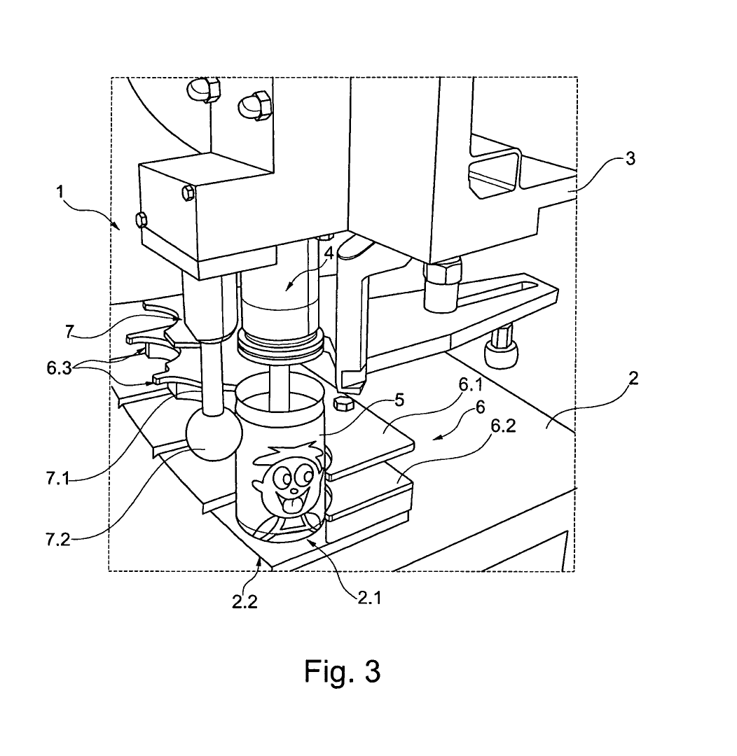

In order to prevent the cans 5 from moving radially outwards from the arc-shaped holders 6, particularly when the rotor 2 and the filling element support 3 are rotating at high angular speeds, the illustrated embodiment has each filling element 4 being assigned a clamping element 7 that is arranged radially outwards, relative to the machine axis MA, on the housing of the filling element 4. This clamping element 7 is designed as a lifting cylinder and has a lifting rod 7.1 that is guided in a cylinder bushing and that has, at the free end, a lifting rod end 7.2 that protrudes radially from the lifting rod 7.1 at least on the side facing towards the can 5, and with this lifting rod end 7.2 comes to bear, preferably on the side diametrically opposite the holder 6, at least partially against the circumference of the can 5, specifically outside the can opening 5.2. The lifting rod 7.1 in this case can be positioned at least in a retracted position (FIG. 2) and in an extended position (FIG. 1, FIG. 3). In the retracted state of the lifting rod 7.1, it is possible for the can to be introduced into or removed from the can holding location 2.1. In the extended state of the lifting rod 7.1, the can is locked in a clamped or substantially clamped manner but at least in a contact-free manner between the lifting rod end 7.2 and the holder 6. The axis of the lifting rod is offset radially relative to the can axis, specifically, radially outwards relative to the machine axis MA.

During operation of the filling device 1 according to the invention, a can 5 is fed to each individual can holder 2.1 at the can pick-up station by being pushed radially inwards relative to the machine axis MA. Here, the lifting rod 7.1 of the clamping element 7 is pushed so far into the lifting cylinder element that the pushing-in of the can 5 is not hindered by the lifting rod end 7.2 at the free end. By pushing out the lifting rod 7.1, the can 5 is then held between the holder 6 and the lifting rod end 7.2 as described above. The controlled filling of the can 5 by means of the filling element 4 located above it takes place in this position. During the filling operation, the can 5 is moved from the can pick-up station to the can set-down station by the rotor 2 which is driven in rotation. Upon reaching the can set-down station, the lifting rod 7.1 is pushed in to release the can for subsequent removal from the can holding location 2.1.

As an alternative, the fixing of the can 5 may take place mechanically by means of two clamping elements that can move with respect to one another in the manner of tongs and that are provided on the rotor 2 or on the filling element support 3.

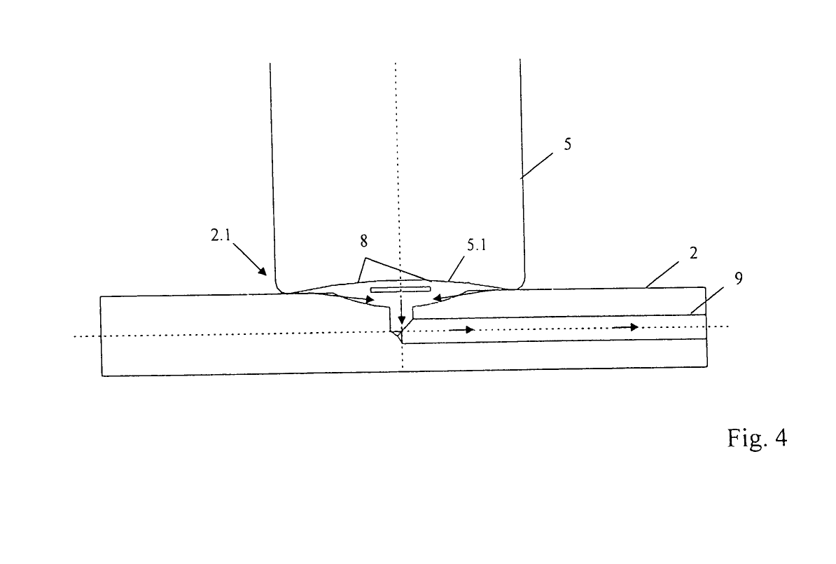

FIG. 4 shows another possibility for fixing the can 5 with respect to the rotor 2, which can be provided as an alternative or in addition to the aforementioned clamping attachment of the can 5 to the rotor 2. To this end, there is provided in the region of the can holder 2.1 at least one opening 8 that is connected to a channel 9 provided in the rotor 2. This channel 9 can be connected to at least one underpressure-generating unit, so that an underpressure is generated on the can bottom 5.1 via the opening 8 and the can 5 is attached to the rotor 2 by suction.

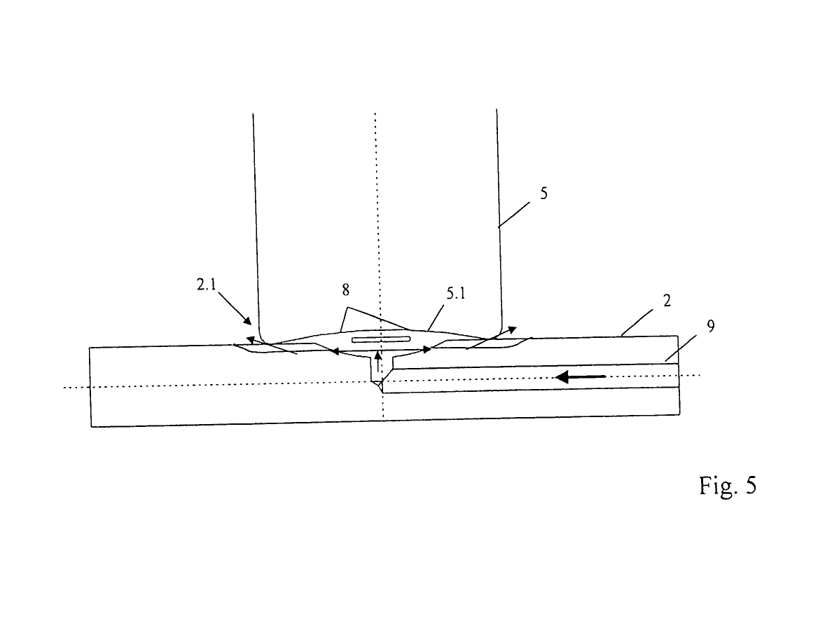

As an alternative, as shown in FIG. 5, compressed air can be fed towards the openings 8 via the channel 9, wherein, as indicated by the arrows, an underpressure is generated on the can bottom 5.1 in a manner comparable to a fluid jet pump due to the compressed air flow escaping laterally below the can bottom 5.1.

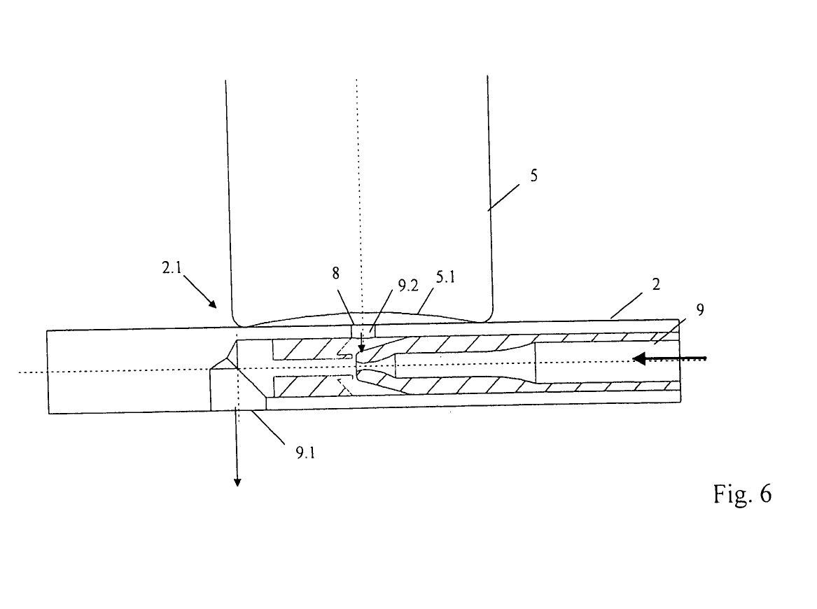

Furthermore, as shown in FIG. 6, there may be provided, within the rotor 2, a channel 9 that has, for example, a channel outlet opening 9.1 that is located opposite the can holder 2.1 and via which compressed air that has been fed into the channel 9 can escape outwards. Incorporated in the rotor 2 is a further channel section 9.2 that runs transversely, in particular at right angles, to the channel 9 and that opens with a channel section end into the channel 9. The other channel section end of the channel section 9.2 forms the opening 8, which is provided in the region of the can holding location 2.1. Passing a flow of compressed air through the channel 9 generates a suction effect similar to that of a fluid jet pump. This suction holds the can bottom 5.1 securely against the rotor 2.

The invention has been described above on the basis of examples of embodiments. It will be understood that numerous changes and modifications are possible without thereby departing from the inventive concept on which the invention is based.

### LIST OF REFERENCES

1 filling device
2 rotor
2.1 can holder or can holding position
2.2 cutout
3 filling element support
3.1 ring bowl
4 filling element
4.1 filling element outlet
5 can
5.1 can bottom
5.2 can opening
6 holder
6.1 first holder element
6.2 second holder element
6.3 recess
6.4 holder mount
7 clamping element
7.1 lifting rod
7.2 lifting rod end
8 opening
9 channel
9.1 channel outlet opening
9.2 channel section
MA machine axis
HA lifting axis

1-10. (canceled)

11. An apparatus for filling cans with an uncarbonated liquid fill, said apparatus comprising a rotatable rotor, can holders, filling elements, a can pickup station, a can set-down station, and means for fixing said cans, wherein said rotatable rotor turns about a vertical machine axis, wherein said can holders are constituents of said rotor, wherein said filling elements are disposed above said can holders, wherein each can holder is associated with a filling element, wherein a can holder and an associated filling element define a filling position, wherein said rotor is configured to, during a filling operation, move a can from said can pick-up station to said can set-down station, wherein said means for fixing said cans is configured such that, during said filling operation, a can with a can opening exposed is fixed at least temporarily to a structure, wherein said structure is selected from the group consisting of a circumferential side with respect to said rotor and a filling-element support, wherein said filling operation is selected from the group consisting of pressureless filling, free-jet filling, and hot free-jet filling, and wherein said means for fixing comprises an element selected from the group consisting of a movable clamping element and an underpressure acting on a bottom of a can.

12. The apparatus of claim 11, wherein said means for fixing comprises a source of underpressure acting on a bottom of said can.

13. The apparatus of claim 11, wherein said means for fixing comprises said movable clamping element.

14. The apparatus of claim 13, further comprising a holder arranged in a stationary manner on said rotor, wherein said holder cooperates with said movable clamping element to fix said can.

15. The apparatus of claim 14, wherein said clamping element is displaceable in the manner of a lifting cylinder along a lifting axis.

16. The apparatus of claim 15, wherein said lifting axis runs parallel to said vertical machine axis.

17. The apparatus of claim 15, wherein said structure comprises said filling-element support, and wherein said clamping element is connected at least indirectly to said filling element support.

18. The apparatus of claim 14, wherein said holder comprises holder elements, wherein said holder elements are spaced apart from one another in the direction of said machine axis.

19. The apparatus of claim 14, wherein said holder comprises holder elements, and wherein said holder elements define an arc-shaped recess adapted to a diameter of can.

20. The apparatus of claim 14, wherein said holder comprises a holder element, wherein said holder element comprises at least a segment of a ring, and wherein said holder has arc-shaped recesses arranged on an outer circumference.

21. The apparatus of claim 11, wherein said fixing means comprises tongs, and wherein said tongs comprise clamping elements that move relative to each other for fixing said can.

22. The apparatus of claim 21, wherein said clamping elements are arranged on said rotor.

23. The apparatus of claim 21, wherein said clamping elements are arranged on said filling element support.

24. The apparatus of claim 11, further comprising an opening in said rotor, wherein said opening is in a region of said can holders, and wherein said opening connects an underpressure-generating unit via a channel in said rotor.

25. The apparatus of claim 11, further comprising an opening in said rotor, wherein said opening is in a region of said can holders, and wherein said opening is connected to a channel through which a fluid flows, whereby said fluid flow generates an underpressure at said opening for fixing said can to said rotor.
